(19) United States
(12) Patent Application Publication
(10) Pub. No.: US 2024/0113597 A1
(43) Pub. Date: Apr. 4, 2024

(54) AUTOMOTIVE ELECTRICAL LIQUID PUMP

(71) Applicant: PIERBURG PUMP TECHNOLOGY GMBH, NEUSS (DE)

(72) Inventors: JENS TEUBEL, NEUSS (DE); RONALD RATHKE, NEUSS (DE)

(73) Assignee: PIERBURG PUMP TECHNOLOGY GMBH, NEUSS (DE)

(21) Appl. No.: 18/265,683

(22) PCT Filed: Dec. 14, 2020
(86) PCT No.: PCT/EP2020/086026

§ 371 Date: Jun. 7, 2023

(51) Int. Cl. H02K 9/22; F04D 13/06; F04D 29/58; H02K 11/33; H02K 21/14

(52) U.S. Cl. CPC H02K 9/223; F04D 13/0626; F04D 29/5893; H02K 11/33; H02K 21/14; H02K 2211/03

(57) ABSTRACT

An automotive electrical liquid pump includes a pump housing which is defined by a pump housing body, a static heat-conducting separating can having a can part and a radial can flange part, an electric motor which drives the automotive electrical liquid pump, a printed circuit board with electronic components for driving the electric motor, and a non-rotatable heat-conducting cooling sleeve. The separating can fluidically separates a wet zone from a dry zone within the pump housing. The electric motor comprises a non-rotatable motor stator arranged within the dry zone and a rotatable motor rotor arranged in the wet zone. The motor rotor is co-rotatably connected to an impeller wheel via a rotatable rotor shaft. The cooling sleeve is arranged to circumferentially surround the motor stator within the dry zone and to be in a direct physical heat-transferring contact with each of the motor stator and the separating can.

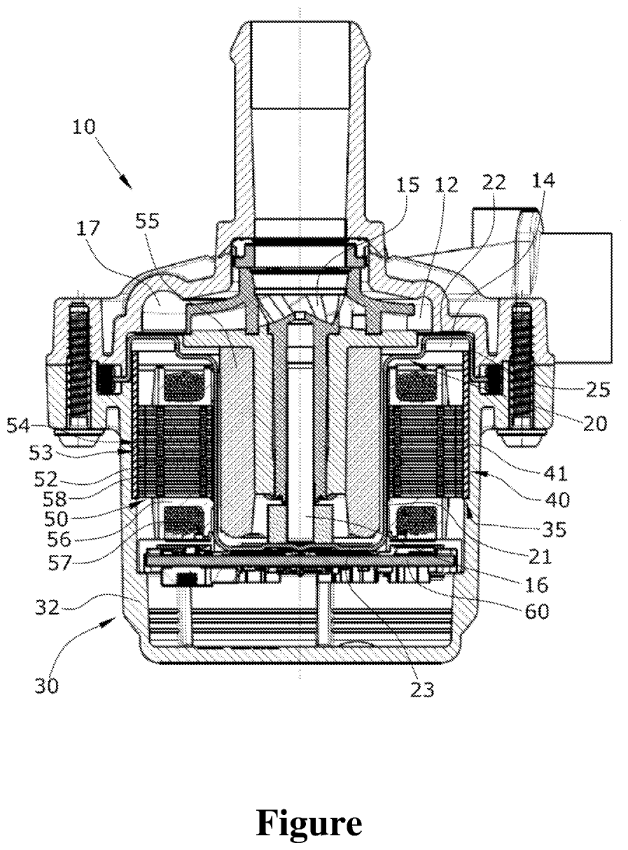

### CROSS REFERENCE TO PRIOR APPLICATIONS

This application is a U.S. National Phase application under 35 U.S.C. § 371 of International Application No. PCT/EP2020/086026, filed on Dec. 14, 2020. The International Application was published in English on Jun. 23, 2022 as WO 2022/128060 A1 under PCT Article 21(2).

### FIELD

The present invention is directed to an automotive electrical liquid pump with an improved heat dissipation, in particular to an electrical water circulation pump for a motor vehicle.

### BACKGROUND

Becasue the electric motor of an electrical liquid pump generates a significant quantity of heat, an effective heat dissipation of the motor components is essential for a high-efficient pump. Electrical liquid pumps can, for example, be provided with an electronically commutated electric motor, wherein the motor stator and the motor rotor are fluidically separated by a separating can which defines a dry zone and a wet zone.

The motor rotor is arranged in the wet zone which is permanently cooled by the pumped liquid. The static motor stator is in contrast arranged in the dry zone together with the electronic power components and is therefore not cooled effectively by the pumped liquid. For providing a cost-efficient and light-weight pump, the pump housing of a state-of-the-art electrical liquid pump is made of a plastic material. The heat dissipation via the pump housing is insufficient due to the low thermal conductivity of plastics.

An example of such an electrical liquid pump is described in WO 2015/121051 A1.

As a result of the insufficient heat dissipation, the performance of the pump is limited by the maximum heat tolerance of the plastic pump housing so that the maximum pumping performance of the pump is relatively low.

For increasing the maximum pump peak performance, CN 208831261 U describes, for example, an electrical liquid pump as described above, but which is additionally provided with a ring channel which is fluidically connected to the pumping chamber and which operates as a cooling jacket for the stator. The ring channel circumferentially surrounds the motor stator so that the pumped liquid flows from the pumping chamber circumferentially through the ring channel and thereby dissipates the heat generated by the stator over its whole circumference.

The additional cooling jacket of CN 208831261 U in fact allows for an increased peak performance of the pump compared to WO 2015/121051 A1, but requires a radially larger installation space, which is disadvantageous for an automotive application. The design structure of the pump is also more complex which results in relatively high material and production costs.

### SUMMARY

An aspect of the present invention is to provide a cost-efficient automotive electrical liquid pump with an improved heat dissipation.

In an embodiment, the present invention provides an automotive electrical liquid pump which includes a pump housing which is defined by a pump housing body, a static heat-conducting separating can comprising a can part and a radial can flange part, an electric motor which is configured to drive the automotive electrical liquid pump, a printed circuit board comprising electronic components for driving the electric motor, and a non-rotatable heat-conducting cooling sleeve. The static heat-conducting separating can is configured to fluidically separate a wet zone from a dry zone within the pump housing of the automotive electrical liquid pump. The electric motor comprises a non-rotatable motor stator which is arranged within the dry zone and a rotatable motor rotor which is arranged in the wet zone. The rotatable motor rotor is co-rotatably connected to an impeller wheel via a rotatable rotor shaft. The non-rotatable heat-conducting cooling sleeve is arranged to circumferentially surround the non-rotatable motor stator within the dry zone and to be in a direct physical heat-transferring contact with each of the non-rotatable motor stator and the static heat-conducting separating can.

### BRIEF DESCRIPTION OF THE DRAWING

The present invention is described in greater detail below on the basis of embodiments and of the drawing in which:

The FIGURE shows an embodiment of an automotive electrical liquid pump according to the present invention in a radial cross-sectional view.

### DETAILED DESCRIPTION

An automotive electrical liquid pump according the present invention comprises a pump housing which is defined by a pump housing body for hermetically separating the inside of the pump from the environment. The automotive electrical liquid pump further comprises a static heat-conducting separating can with a can part and a can flange part. The can part can, for example, be defined by a tube-like body with two open axial ends or alternatively by a pot-like body with one open axial end and one closed axial end. The separating can fluidically separates the inside of the pump into a wet zone and a dry zone. In the wet zone, the internal pump components are in fluidic contact with the liquid being pumped by the automotive electrical liquid pump. The dry zone is hermetically sealed from the wet zone so that none of the pumped liquid enters the dry zone, which prevents the sensitive electric and electronic components from contacting the liquid. The automotive electrical liquid pump is driven by an internal electric motor which comprises a non-rotatable motor stator and a rotatable motor rotor. The motor stator is arranged at the outside of the separating can within the dry zone, whereas the motor rotor is arranged at the inside of the separating can within the wet zone. The motor rotor is co-rotatably connected to an impeller wheel via a rotatable rotor shaft and thereby drives the impeller wheel for pumping the liquid through the liquid cooling circuit.

The motor stator is provided with induction coils for generating a magnetic field, which electromagnetically drives the motor rotor and is, as a result of the physical separation of the rotor and the stator, electronically commutated. For electronically commutating the magnetic field, the pump is provided with a printed circuit board which is provided with power electronic components. The motor stator, acting as a shared core for the coils, heats up as a result of the electrical current flow of the induction coils. The heat of the stator results in a significant heat input into the pump housing. As the pump housing can, for example, be made of a plastic material, this poor heat-conducting material does not sufficiently dissipate the generated heat of the stator via the pump housing to the environment so that the heat accumulates within the pump housing.

For avoiding the heat accumulation within the pump housing, the automotive electrical liquid pump is provided with a non-rotatable heat conducting cooling sleeve for dissipating the heat generated by the motor stator. The cooling sleeve is arranged within the dry zone of the pump and circumferentially surrounds the motor stator so that the cooling sleeve and the stator are in direct physical contact with each other. The cooling sleeve can, for example, be defined by a cylindrical cooling sleeve which axially extends towards the liquid-guiding part of the pump, for example, in a direction of the pump wheel. The cooling sleeve is in direct physical contact to the separating can because the most effective cooling is achieved by the circulating liquid within the pumping chamber. The separating can is in permanent fluidic contact with the pumped liquid and is therefore particularly suitable for dissipating the heat of the thermally loaded pump components.

The cooling sleeve can, for example, be made of a metallic material with a sufficient thermal conductivity, which should, for example, be at least 30 W/mK. Due to the relatively high thermal conductivity, the cooling sleeve permanently absorbs the heat generated by the motor stator and transfers it to the heat conductive separating can. As a result of the forced convection, the separating can in turn transfer the heat to the pumped liquid circulating at the inside of the separating can. The heat of the stator is thereby constantly and effectively transported away from the stator indirectly into the liquid circuit so that a relevant heat accumulation within the pump housing is at least reduced or completely avoided.

In an embodiment of an automotive electrical liquid pump according to the present invention, the cooling sleeve can, for example, be press-fitted onto the motor stator. The cooling sleeve is thereby connected to the stator by a frictional connection with an interference fit to fix the cooling sleeve at the stator, for example, during the assembly process of the pump. The press-fitted connection provides a direct physical contact between the cooling sleeve and the stator and provides a tight fit of the cooling sleeve with a relatively large heat transferring contact surface between the stator and the cooling sleeve so that a relatively large quantity of heat is transferred to the cooling sleeve. The cooling sleeve thereby absorbs any relevant heat which is generated by the motor stator resulting from the current flow in the induction coils and transfers the heat towards the liquid guiding section of the pump, where the heat is transferred to the liquid and is thereupon transported into the liquid circuit of the vehicle.

In an embodiment of the present invention, the separating can can, for example, be provided with a cylindrical protrusion part for providing a direct physical heat transferring contact with the cooling sleeve. The cylindrical protrusion part axially extends from the radial can flange part at an open axial end of the separating can which is oriented towards the liquid guiding section of the pump. The cylindrical protrusion part extends towards the motor stator so that the cooling sleeve can contact the cylindrical protrusion part at the radial outside or at the radial inside.

The cooling sleeve can, for example, contact the cylindrical protrusion part radially to provide a relatively large heat transferring surface and to thereby transfer a relatively large heat quantity to the separating can. The heat is transferred via the radial can flange part to the can part, which is in fluidic contact with the pumped liquid, or is transferred directly from the can flange part to the liquid, so that the heat is effectively transported away from the pump into the liquid circuit.

In an embodiment of the present invention, the cooling sleeve can, for example, be press fitted into the cylindrical protrusion part. The cooling sleeve is thereby connected to the cylindrical protrusion part of the separating can via a frictional connection with, for example, an interference fit. The radial press fitted connection provides a relatively large heat transferring contact surface between the cooling sleeve and the separating can via the cylindrical protrusion part with a relatively large heat quantity transfer. The heat which is absorbed by the cooling sleeve is thereby effectively transferred to the separating can via the radial can flange part and is transferred to the liquid within the liquid guiding section of the pump, for example, the pumping chamber. The liquid then absorbs the heat via heat convection and transports the heat away from the pump into the liquid circuit.

The connection between the cooling sleeve and the cylindrical protrusion part can alternatively, for example, be laser-welded to provide a material bonded connection. A material-bonded connection via welding or via any other equivalent connection method merges both the material of the cooling sleeve and of the separating can so that a direct heat transferring connection exists via the metal structure of the merged materials which can increase the heat transfer compared to a press-fitted connection.

The pump housing body can, for example, be provided with an axial stop for defining the axial position of the cooling sleeve. The axial stop precisely defines the axial position of the cooling sleeve to provide a sufficient axial overlap of the cooling sleeve at both axial ends with both the motor stator and with the separating can. The axial stop can, for example, be defined by a platform-like structure at the inner radial side of the pump housing to which the cooling sleeve is moved during its insertion into the pump housing. The assembly is thereby simplified and does not require a time consuming measurement of the axial position of the cooling sleeve during the assembly.

In an embodiment of an automotive electrical liquid pump according to the present invention, the pump housing body of the pump can, for example, be made of a plastic material. The application of a plastic pump housing has major advantages regarding the weight reduction of the pump housing and regarding the cost-efficiency of the pump. In an automotive application, the weight reduction of the peripherical components of the traction system is in particular an essential purchasing argument for vehicle manufacturers, provided that the performance of the pump is not affected thereby. In state-of-the-art pumps, the performance of the pumps must be limited to avoid a heat accumulation at the inside of the pump and to thereby protect the thermosensitive plastic pump housing. In contrast thereto, with an automotive electrical liquid pump according to the present invention, the heat accumulation within the pump housing is, despite a relatively high performance output of the pump, significantly reduced. The pump is thereby provided with a relatively high electrical efficiency while at the same time being cost-efficient and having a light weight.

In an embodiment of the present invention, the motor stator, the cooling sleeve, and the printed circuit board together define a pre-assembled unit. The pre-assembled unit simplifies the assembly process of the pump and allows for a more precise positioning of the pre-assembled components with respect to each other. In combination with the axial stop at the pump housing, the assembly process is simple and is in particular suitable for a serial production of the pump with high quantities resulting in a particularly cost-efficient automotive electrical liquid pump with an increased electric efficiency over the prior art.

An embodiment of the present invention is described below with reference to the enclosed drawing.

The FIGURE shows an automotive electrical liquid pump 10 according to the present invention which is designed as an electrical water circulation impeller pump. The pump 10 comprises a static pump housing 30 which is defined by a substantially cylindrical pump housing body 32, which is made of a plastic material. The pump 10 further comprises a metallic heat-conducting separating can 20 with a cylindrical pot-type can part 21 comprising an integrated separating can bottom wall 23 and with a substantially radially extending ring-shaped can flange part 22 which is connected to the open end of the can part 21 and which extends radially outwards. The separating can 20 fluidically separates a wet zone 12 from a dry zone 14 for protecting the liquid-sensitive electric and electronic components of the pump 10 from contacting the liquid. The separating can 20 is also provided with a cylindrical protrusion part 25 which is connected to the outer radial edge of the can flange part 22 and which extends in an axial direction towards the closed axial end of the can part 21.

The pump 10 comprises an electric motor 50 with a static ring-shaped motor stator 52 and a cylindrical and rotatable motor rotor 55. The motor stator 52 and the motor rotor 55 are separated by the separating can 20. The motor rotor 55 is thereby arranged within the wet zone 12 of the pump 10 at the radial inside of the can part 21 which is permanently cooled by the circulating liquid in the wet zone 12. The motor rotor 55 is arranged concentrically to the inner cylinder surface of the can part 21 and is co rotatably connected to an impeller wheel 15 via a cylindrical rotor shaft 16.

The motor rotor 55 thereby drives the impeller wheel 15 within a pumping chamber 17 for pumping water within a water circuit. The motor stator 52 is arranged within the dry zone 14 concentrically surrounding the cylinder surface of the can part 21 and thereby concentrically surrounds the motor rotor 55. The motor stator 52 comprises a motor stator body 58 which is defined by a stator metal sheet stack 53. The stator poles 54 are provided with electromagnetic induction coils 57 which are each wound at a separate ring-shaped supporting structure 56, which is attached to the stator pole 54, one supporting structure 56 with an induction coil 57 being arranged at each stator pole 54. The motor stator 52 acts as common iron core for the induction coils so that, when current is applied to the induction coils 57, the induction coils 57 are magnetized and thereby electromagnetically drive the motor rotor 55 which is permanently magnetized.

The pump 10 also comprises a circular printed circuit board 60 which is provided with power electronic components for driving the electric motor 50. The printed circuit board 60 is, for example, provided with a commutator for electronically commutating the magnetic field of the motor stator 52, which drives the motor rotor 55. The printed circuit board is arranged axially next to the separating can bottom wall 23 within the dry zone 14 for dissipating the heat of the power electronic components via the separating can 20 to the liquid circulating at the opposite side of the separating can bottom wall 23 within the wet zone 12.

For dissipating the generated heat of the motor stator 52 resulting from the current flow within the induction coils 57, the pump 10 comprises a hollow cylindrical metallic cooling sleeve 40 which is defined by a cylindrical cooling sleeve body 41, which is made of a heat conducting material with a heat conductivity of at least 30 W/mK, for example, of steel. The cooling sleeve 40 circumferentially surrounds the motor stator 52 and is frictionally connected to the motor stator body 58 via a press-fitted connection with an interference fit. The cooling sleeve 40 completely covers the radial outside of the motor stator body 58, in which one axial end of the cooling sleeve 40 is flush to one axial end of the motor stator 52 which is directed towards the printed circuit board 60. The other axial end of the cooling sleeve 40 axially extends the motor stator body 58 and axially extends to the cylindrical protrusion part 25 of the separating can 20. The cooling sleeve 40 is press-fitted into the cylindrical protrusion part 25 so that the cooling sleeve 40 and the cylindrical protrusion part 25 are axially overlapping. The cooling sleeve 40 and the cylindrical protrusion part 25 are thereby radially in a direct physical and heat-transferring contact.

Due to the press-fitted connection, the cooling sleeve 40 and the motor stator 52 also define a heat-transferring connection. The generated heat of the motor stator 52 is transferred to the cooling sleeve 40 and is absorbed by the cooling sleeve 40. The cooling sleeve conducts the heat axially towards the cylindrical protrusion part 25 of the separating can 20, and the heat is transferred via the heat transferring contact surface defined by the overlapping radial press-fitted connection to the cylindrical protrusion part 25. The cylindrical protrusion part 25 absorbs the heat and conducts it to the can flange part 22, from where it is transferred to the water circulating within the pumping chamber 17. The heated water is pumped, via the rotation of the impeller wheel 15, into the water circuit, where it is cooled, for example, by an intercooler.

The motor stator 52, the cooling sleeve 40, and the printed circuit board 60 are assembled as a unit which is pre-assembled before assembling the pump 10. This pre-assembled unit is axially inserted into the pump housing body 32. For defining the axial position of the pre-assembled unit, the pump housing body 32 is provided with a platform-like axial stop 35 which extends circumferentially at the inner cylindrical surface of the pump housing body 32. After the pre-assembled unit has been mounted to the pump housing body 32, the separating can 20 is inserted into the pump housing 30 and the cylindrical protrusion part 25 of the separating can 20 is press-fitted to the cooling sleeve 40 so that the pre-assembled unit and, in particular, the stator are unidirectionally fixed within the pump housing not requiring any additional fixing elements, which results in a simple and cost-efficient assembly of the pump 10.

The present invention is not limited to embodiments described herein; reference should be had to the appended claims.

### LIST OF REFERENCE NUMERALS

10 Automotive electrical liquid pump/Pump
12 Wet zone
14 Dry zone
15 Impeller wheel
16 Cylindrical rotor shaft
17 Pumping chamber
20 Metallic heat-conducting separating can/Separating can
21 Cylindrical pot-type can part/Can part
22 Radially extending ring-shaped can flange part/Can flange part
23 Separating can bottom wall
25 Cylindrical protrusion part
30 Pump housing
32 Pump housing body
35 Axial stop
40 Hollow cylindrical metallic cooling sleeve/Cooling sleeve
41 Cylindrical cooling sleeve body
50 Electric motor
52 Static ring-shaped motor stator/Motor stator
53 Stator metal sheet stack
54 Stator pole(s)
55 Cylindrical and rotatable motor rotor/Motor rotor
56 Separate ring-shaped supporting structure/Supporting structure
57 Electromagnetic induction coils/Induction coil(s)
58 Motor stator body
60 Printed circuit board

What is claimed is:

1-11. (canceled)

12. An automotive electrical liquid pump comprising:
a pump housing which is defined by a pump housing body;
a static heat-conducting separating can comprising a can part and a radial can flange part, the static heat-conducting separating can being configured to fluidically separate a wet zone from a dry zone within the pump housing of the automotive electrical liquid pump;
an electric motor which is configured to drive the automotive electrical liquid pump, the electric motor comprising a non-rotatable motor stator which is arranged within the dry zone and a rotatable motor rotor which is arranged in the wet zone, the rotatable motor rotor being co-rotatably connected to an impeller wheel via a rotatable rotor shaft;
a printed circuit board comprising electronic components for driving the electric motor; and
a non-rotatable heat-conducting cooling sleeve which is arranged to circumferentially surround the non-rotatable motor stator within the dry zone and to be in a direct physical heat-transferring contact with each of the non-rotatable motor stator and the static heat-conducting separating can.

13. The automotive electrical liquid pump as recited in claim 12, wherein the non-rotatable heat-conducting cooling sleeve is defined by a cylindrical cooling sleeve body.

14. The automotive electrical liquid pump as recited in claim 12, wherein the non-rotatable heat-conducting cooling sleeve is made of a heat-conducting metallic material.

15. The automotive electrical liquid pump as recited in claim 12, wherein the non-rotatable heat-conducting cooling sleeve is press-fitted onto the non-rotatable motor stator.

16. The automotive electrical liquid pump as recited in claim 12, wherein the static heat-conducting separating can further comprises a cylindrical protrusion part which is arranged to extend axially from the radial can flange part.

17. The automotive electrical liquid pump as recited in claim 16, wherein the non-rotatable heat-conducting cooling sleeve radially contacts the cylindrical protrusion part of the static heat-conducting separating can.

18. The automotive electrical liquid pump as recited in claim 16, wherein the non-rotatable heat-conducting cooling sleeve is press-fitted into the cylindrical protrusion part.

19. The automotive electrical liquid pump as recited in claim 16, wherein the non-rotatable heat-conducting cooling sleeve and the cylindrical protrusion part are connected to each other via a laser-welding.

20. The automotive electrical liquid pump as recited in claim 12, wherein the pump housing body comprises an axial stop which defines an axial position of the non-rotatable heat-conducting cooling sleeve.

21. The automotive electrical liquid pump as recited in claim 12, wherein the pump housing body is made of a plastic material.

22. The automotive electrical liquid pump as recited in claim 12, wherein the non-rotatable motor stator, the non-rotatable heat-conducting cooling sleeve, and the printed circuit board together define a pre-assembled unit.
